(19) United States
(12) Patent Application Publication
(10) Pub. No.: US 2025/0392572 A1
(43) Pub. Date: Dec. 25, 2025

(54) CLOUD-TO-CLOUD ROUTING OF DEVICE TRAFFIC

(71) Applicant: Amazon Technologies, Inc., Seattle, WA (US)

(72) Inventors: Rongsheng Huang, San Jose, CA (US); Marco Morais, Santa Clara, CA (US); Hongbo Tian, Fremont, CA (US); Yinghua Ye, Los Gatos, CA (US); Jungtao Liu, Saratoga, CA (US); Davinder Singh Naruka, Mill Creek, WA (US)

(21) Appl. No.: 18/753,395

(22) Filed: Jun. 25, 2024

(51) Int. Cl. H04L 9/40; H04L 45/42

(52) U.S. Cl. CPC H04L 63/0263; H04L 45/42; H04L 63/083

(57) ABSTRACT

Disclosed are various embodiments for routing device traffic from one cloud to another cloud using connectors and account-based linking. In one embodiment, a serving cloud receives network traffic to be sent to a destination cloud different from the serving cloud. The network traffic is relative to a device managed in the destination cloud. A particular connector from a plurality of connectors that are capable of forwarding the network traffic from the serving cloud to the destination cloud is determined based at least in part on a connector selection rule set. The network traffic is forwarded via the particular connector to the destination cloud.

### BACKGROUND

In recent years, the proliferation of Internet of Things (IoT) devices has significantly transformed the way we interact with and manage our surroundings. IoT devices may be characterized by their ability to collect, process, and exchange data with other devices and systems over the internet. These devices have found applications in diverse sectors, including healthcare, agriculture, transportation, smart homes, industrial automation, and more. The concept of IoT revolves around the interconnection of everyday objects and systems, enabling them to communicate and collaborate. These devices may be designed to monitor and interact with their environment autonomously, enabling data-driven decision-making, real-time control, and enhanced efficiency in various domains. IoT devices encompass a wide range of form factors and functionalities, from small, low-power sensors to complex, high-performance devices. These devices can be found in various settings, including smart thermostats, wearable fitness trackers, autonomous vehicles, industrial robots, and smart city infrastructure.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A is a drawing of an example scenario involving a networked environment including a service cloud, connectors, and a destination cloud according to various embodiments of the present disclosure.

FIG. 1B is a drawing of an example scenario involving a networked environment including a service cloud, connectors, and a plurality of destination clouds according to various embodiments of the present disclosure.

FIG. 2 is a schematic block diagram of a networked environment according to various embodiments of the present disclosure.

FIGS. 3 and 4 are flowcharts illustrating examples of functionality implemented as portions of a serving cloud in the networked environment of FIG. 2 according to various embodiments of the present disclosure.

FIG. 5 is a flowchart illustrating one example of functionality implemented as portions of a connector in the networked environment of FIG. 2 according to various embodiments of the present disclosure.

FIG. 6 is a schematic block diagram that provides one example illustration of a computing environment employed in the networked environment of FIG. 2 according to various embodiments of the present disclosure.

### DETAILED DESCRIPTION

The present disclosure generally relates to facilitating cloud-to-cloud routing of device traffic, for example, for Internet of Things (IoT) devices. IoT devices typically communicate with services operated by the device vendor for command and control, reporting, data storage, processing, and other functions. As used herein, the term “cloud” refers to a collection of services or services operated by or on behalf of a particular entity, such as a device vendor. For example, a smart door lock may communicate with the vendor's cloud in order to report status (e.g., battery level, whether the device is locked or unlocked) and facilitate remote control via mobile applications or web-based gateways (e.g., remote opening of the lock, remote configuration of access codes). The communication may be by way of customized vendor-specific application programming interfaces (APIs).

Unfortunately, each device vendor operates its own cloud, and the clouds are not interoperable.

For users of IoT devices, it would be appealing to have a single place to control all of their IoT devices in their home or business, which might come from different clouds. Various embodiments of the present disclosure introduce approaches for cloud-to-cloud routing of IoT device traffic. Cloud-to-cloud routing can be facilitated through the use of one or more connectors between a serving cloud and a destination cloud. Connectors are the entities that bridge the serving cloud and the destination cloud after the end user account linking is accomplished. For the network traffic originated by the serving cloud, the connectors take the traffic and along with an access token, translate that traffic to a format that the destination cloud can understand, and then forward the traffic to the destination cloud. For the network traffic originated from the destination cloud and to be sent to the serving cloud, the connectors also perform the translation and send the data back to the serving cloud with recognizable device identifiers. In some embodiments, network traffic may be capable of being routed through a plurality of different connectors, and the serving cloud may select one or more of the different connectors for routing particular network traffic.

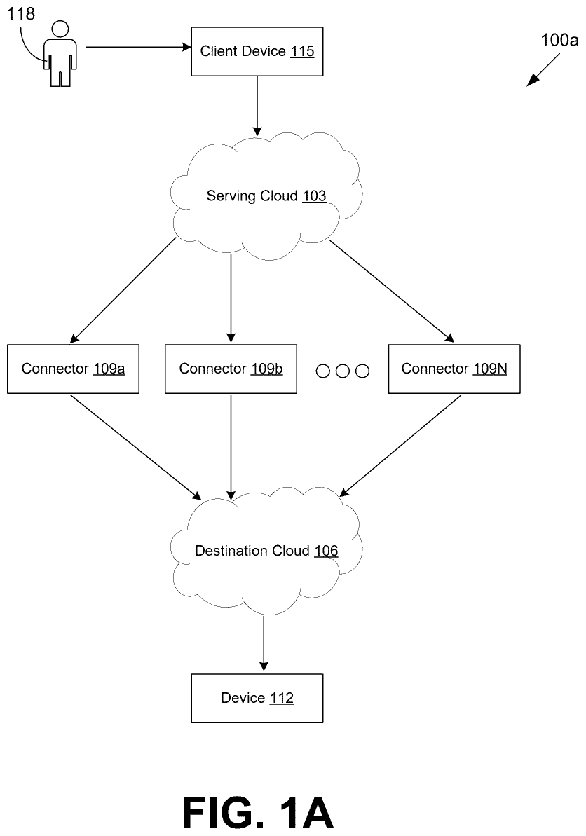

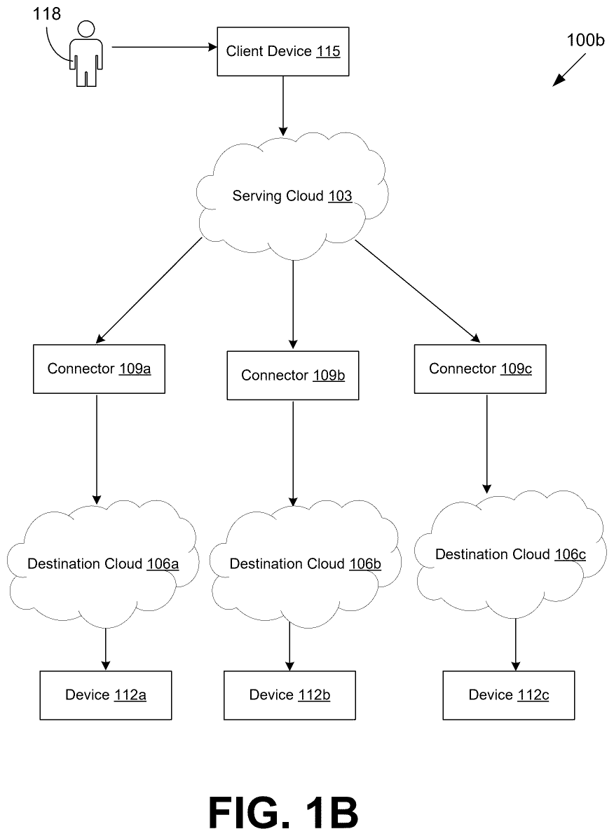

Turning now to FIG. 1A, shown is one example of a networked environment 100a according to one or more embodiments. The networked environment 100a includes a serving cloud 103 and a destination cloud 106. Each “cloud” corresponds to a networked collection of services or servers operated by an entity. In one example, the serving cloud 103 is operated by a third party or an entity who supports device hubs or registration of devices within an environment, such as a home network. The destination cloud 106 may be operated by a device vendor. The destination cloud 106 may support proprietary APIs and functionality specific to the devices sold by the device vendor. The destination cloud 106 may have an authentication mechanism and provide access control to the APIs and functionality.

A plurality of connectors 109a, 109b . . . 109N may be available to route network traffic respecting a device 112 to a destination cloud 106. The device 112 may be an IoT device, such as a smart appliance, a thermostat, a sensor, a smart light, and so on. Such network traffic may comprise commands for the device 112, requests for data from the device 112, status queries for the device 112, and so on.

Each connector 109 may correspond to a container, a virtual machine instance, etc., and the connector 109 may perform routing of communication between the serving cloud 103 and the destination cloud 106. Some connectors 109 may be publicly available, while others may be private and available only to specific customers, but not to the public. The connectors 109 may be operated by the entity who operates the serving cloud 103, the entity who operates the destination cloud 106, a customer who owns the devices 112, or a third-party entity, such as a communications service provider (CSP). Some connectors 109 may correspond to different service tiers, such as free or premium, which may offer support for different capabilities of the device 112. Different connectors 109 may have different quality-of-service levels, which may differ in terms of latency, bandwidth, jitter, etc.

In an example usage scenario, a client device 115, such as a smartphone, may be operated by a user 118 to connect to a device management service in the serving cloud 103. The user 118 may supply one or more security credentials to identify an account of the user 118 to the serving cloud 103. The device management service may then support account-based linking for the user 118 to supply one or more security credentials associated with an account in the destination cloud 106.

The user 118 may interact with the device management service in the serving cloud 103 to generate network traffic (e.g., API calls) with respect to the device 112. One of the plurality of connectors 109 will be selected to route the network traffic to the destination cloud 106 according to one or more connector selection rules. The serving cloud 103 then sends the network traffic to the selected connector 109. The selected connector 109 may then optionally perform translation (e.g., translation from one API to another API, or translation from one data model to another data model) or other processing (e.g., transcoding, data reduction) on the network traffic and then forward the network traffic to the destination cloud 106. The network traffic may cause a command to be performed in the device 112, query data generated by the device 112 (e.g., video data), query status of the device 112, and other actions. An access token may be provided to the selected connector 109 based at least in part on the account-based linking, and used to authenticate to the destination cloud 106 to ensure that the proper access rights are present. Return network traffic (e.g., the requested data, responses to the commands) may be generated from the destination cloud 106 and sent by the selected connector 109 back to the serving cloud 103.

FIG. 1B shows one example of a networked environment 100b according to one or more embodiments including a plurality of destination clouds 106a, 106b, 106c. The serving cloud 103 is linked to each respective destination cloud 106 using a corresponding connector 109a, 109b, 109c, where each may be representative of a corresponding plurality of connectors 109a, 109b, or 109c. Attached to each respective destination cloud 106 is a respective device 112a, 112b, or 112c, where each may be representative of a corresponding plurality of devices 112a, 112b, or 112c. In the example of FIG. 1B, the serving cloud 103 may act as a bridge to connect two destination clouds 106 together, which may allow for communication between device 112a of destination cloud 106a and device 112b of destination cloud 106b, for example.

As one skilled in the art will appreciate in light of this disclosure, certain embodiments may be capable of achieving certain advantages, including some or all of the following: (1) improvements to the functioning of computer networks by allowing for communication between disparate clouds that support different APIs; (2) improvements to the functioning of computer networks by allowing management of IoT devices via multiple clouds; (3) improvements to the functioning and reliability of computer systems through the use of connectors 109 that can be selected to ensure quality-of-service in terms of latency, jitter, bandwidth, and other characteristics; and so forth.

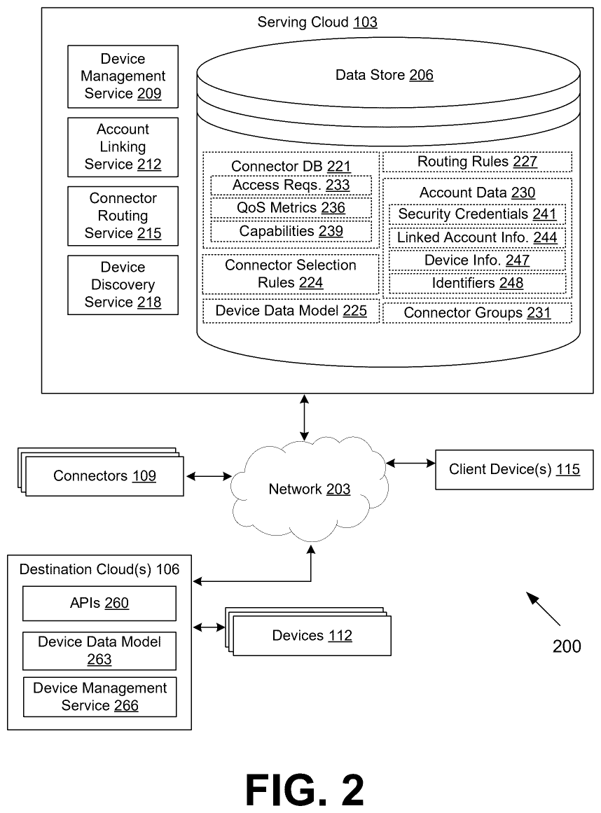

With reference to FIG. 2, shown is a networked environment 200 according to various embodiments. The networked environment 200 includes a serving cloud 103, one or more destination clouds 106, a plurality of connectors 109, and one or more client devices 115, which are in data communication with each other via a network 203. The network 203 includes, for example, the Internet, intranets, extranets, wide area networks (WANs), local area networks (LANs), wired networks, wireless networks, cable networks, satellite networks, or other suitable networks, etc., or any combination of two or more such networks. The destination cloud(s) 106 may be in data communication with the devices 112 over the network 203 or another network.

The serving cloud 103 may comprise, for example, a server computer or any other system providing computing capability. Alternatively, the serving cloud 103 may employ a plurality of computing devices that may be arranged, for example, in one or more server banks or computer banks or other arrangements. Such computing devices may be located in a single installation or may be distributed among many different geographical locations. For example, the serving cloud 103 may include a plurality of computing devices that together may comprise a hosted computing resource, a grid computing resource, and/or any other distributed computing arrangement. In some cases, the serving cloud 103 may correspond to an elastic computing resource where the allotted capacity of processing, network, storage, or other computing-related resources may vary over time.

Various applications and/or other functionality may be executed in the serving cloud 103 according to various embodiments. Also, various data is stored in a data store 206 that is accessible to the serving cloud 103. The data store 206 may be representative of a plurality of data stores 206 as can be appreciated. The data stored in the data store 206, for example, is associated with the operation of the various applications and/or functional entities described below.

The components executed on the serving cloud 103, for example, include a device management service 209, an account linking service 212, a connector routing service 215, a device discovery service 218, and other applications, services, processes, systems, engines, or functionality not discussed in detail herein. The device management service 209 is executed to facilitate management of devices 112, such as IoT devices 112, across the serving cloud 103 and potentially one or more destination clouds 106. Such management activities may include sending commands to the devices 112, querying status of the devices 112, retrieving data generated by the devices 112, configuring operation of the devices 112, and so forth.

In some cases, the device management service 209 is associated with a control device, such as a device hub, a voice interface device, a tablet computing device, etc., associated with a customer account in an environment, such as a home environment, a medical facility, an industrial facility, etc. The control device may facilitate communication with devices 112 on one or more local area networks via WI-FI, BLUETOOTH, ZIGBEE, Z-WAVE, Ethernet, and other communications protocols. Some devices 112 of the customer may be managed through the serving cloud 103, while other devices 112 of the customer may be managed through a destination cloud 106 such as a cloud of the vendor of the device 112. As will be described, the device management service 209 may be configured to provide ubiquitous control of all devices 112 owned by an entity, regardless of whether they are connected to different clouds.

The account linking service 212 is executed to facilitate account-based linking of customer accounts with the serving cloud 103 and accounts of the same customers with the destination clouds 106. That is to say, a customer may have a first account with the serving cloud 103, a second account with a first destination cloud 106, a third account with a second destination cloud 106, and so on. After authenticating a user's access to the first account, the account linking service 212 can receive a security credential from the user for the second account, and the account linking service 212 may communicate with a service on the first destination cloud 106, potentially through a connector 109, in order to obtain an access token that will permit the serving cloud 103 to communicate with first destination cloud 106 regarding one or more devices 112 in the first destination cloud 106 that are owned or controlled by the second account.

The connector routing service 215 is executed to select connectors 109 to route network traffic between the serving cloud 103 and a particular destination cloud 106. Multiple connectors 109 may be available for routing network traffic between the serving cloud 103 and the particular destination cloud 106, so the connector routing service 215 is configured to select a particular connector 109 for use on the basis of a rule set. The device discovery service 218 is executed to discover the availability of devices 112 to be managed by the device management service 209 once the service cloud 103 and the destination cloud 106 are connected by a connector 109 and linked through account-based linking.

The data stored in the data store 206 includes, for example, a connector database (DB) 221, one or more connector selection rules 224, one or more device data models 225, one or more routing rules 227, account data 230, one or more connector groups 231, and potentially other data. The connector database 221 includes data regarding the connectors 109 that are available to link the serving cloud 103 with destination clouds 106. The data may include various identifiers, such as a serving cloud 103 identifier, a customer identifier, a connector group identifier, etc. The connectors 109 may be associated with one or more access requirements 233, one or more quality-of-service (QOS) metrics 236, one or more capabilities 239, energy consumption data, and other data.

The access requirements 233 may define a service tier associated with the connector 109, such as free or basic, or premium or advanced. These service tiers may be associated with a required subscription or status associated with the account. A higher-level service tier may offer higher QoS in terms of reliability, bandwidth, latency, jitter, etc. A higher-level service tier may also offer enhanced capabilities 239 which are not present or disabled by the basic or lower-level service tier. In some cases, the access requirements 233 may indicate that the connector 109 is public and available to all customers, or the access requirements 233 may indicate that the connector 109 is private and available only to a particular customer or enumerated set of customers.

The QoS metrics 236 may be indicative of a quality-of-service level associated with a connector 109. For example, some connectors 109 may provide a higher QoS than others because some connectors 109 may be allocated additional resources or may be located in a more favorable location. The QoS metrics 236 may express QoS in terms of reliability, bandwidth, jitter, latency, etc., and the QoS metrics 236 may change over time. For example, a connector 109 that previously provided good QoS may become overloaded and QoS may become degraded.

The capabilities 239 corresponds to a feature set or capability set supported by the connector 109. The connector 109 may support all types of devices 112 in a destination cloud 106, or a subset of one or more of the types of devices 112. The capabilities 239 may correspond to features inherently provided by the devices 112, or features provided through processing capabilities of the destination cloud 106. Some connectors 109 may offer additional capabilities 239 compared to other connectors 109. For example, one connector 109 supporting a video doorbell may support receiving alerts or viewing current video, while another connector 109 supporting the video doorbell may additionally support reviewing previously recorded video streams.

The connector selection rules 224 correspond to a rule set that controls the selection of connectors 109. For example, the connector selection rules 224 may indicate that for a particular type of device 112 to be managed, a particular connector 109 should always be chosen first if available. The connector selection rules 224 may operate on QoS metrics 236, capabilities 239, access requirements 233, energy consumption of connectors 109, and characteristics associated with customer accounts (e.g., whether the customer qualifies for basic or advance level, whether the customer has a subscription to a particular connector 109). With respect to energy consumption, different connectors 109 may have differing levels of energy consumption, which may be based on the respective capabilities supported by the connector 109. That is to say, one connector 109 may use more energy to offer more capabilities, but another connector 109 may have fewer capabilities and use less energy. If certain capabilities of the connector 109 are not needed to process certain network traffic, the connector selection rules 224 may indicate that the connector 109 supporting at least a minimal set of required capabilities with the lowest energy consumption is selected.

The device data models 225 may correspond to data models of mutable and/or immutable state maintained by the respective devices 112. The connectors 109 may translate a device data model 225 for a device 112 in the serving cloud 103 to a different device data model for a device 112 in a destination cloud 106, and vice versa.

The routing rules 227 may be used to configure connectors 109 to route certain types of network traffic in a particular manner. For example, a connector 109 may offer a dynamic behavior to route network traffic in different ways based upon supplied routing rules 227 or criteria.

The account data 230 corresponds to data regarding customer accounts with the serving cloud 103. The account data 230 may include one or more security credentials 241, linked account information 244, device information 247, one or more identifiers 248, and/or other data. The security credentials 241 may include usernames, passwords, keys, tokens, etc., that are used to authenticate client devices 115 and provide access to resources of an account in a serving cloud 103. Linked account information 244 may include information about accounts with destination clouds 106 that are linked to accounts of the serving cloud 103. Such information may include access tokens or credentials, account usernames, etc. The linked account information 244 may enable access to the connector 109, or for the connector 109 to be able to access the destination cloud 106. The device information 247 may include information about devices 112 that are managed by the device management service 209, either devices 112 in the serving cloud 103 or devices 112 in a destination cloud 106 connected via a connector 109 to the serving cloud 103.

The identifiers 248 may include one or more group identifiers or one or more owner identifiers that can be used to link an account with a third-party authentication service, such as a federated identity provider. In some cases, the identifiers 248 will take the place of the security credentials 241 in the serving cloud 103, where a third party is performing identify verification and authentication.

The connector groups 231 may define a set of one or more connectors 109 that can be used to access resources related to a particular device 112 on a destination cloud 106. In some cases, the connector groups 231 may specified by a user based on the user's preferences in terms of cost, QoS, and other factors.

The destination cloud 106 and the serving cloud 103 may be operated by different entities, though in some scenarios, the destination cloud 106 may be a private cloud within the serving cloud 103 or utilizing resources of the serving cloud 103. The destination cloud 106 may comprise, for example, a server computer or any other system providing computing capability. Alternatively, the destination cloud 106 may employ a plurality of computing devices that may be arranged, for example, in one or more server banks or computer banks or other arrangements. Such computing devices may be located in a single installation or may be distributed among many different geographical locations. For example, the destination cloud 106 may include a plurality of computing devices that together may comprise a hosted computing resource, a grid computing resource, and/or any other distributed computing arrangement. In some cases, the destination cloud 106 may correspond to an elastic computing resource where the allotted capacity of processing, network, storage, or other computing-related resources may vary over time.

Various applications and/or other functionality may be executed in the destination cloud 106 according to various embodiments. The components executed on the destination cloud 106, for example, include APIs 260, one or more device data models 263, and other applications, services, processes, systems, engines, or functionality not discussed in detail herein. The APIs 260 may be made available to authenticated users or client devices 115 to manage devices 112. In various scenarios, the APIs 260 may be proprietary to the destination cloud 106. For example, the device vendor may publish a mobile application or host a web portal that allows users to manage their devices 112, where the mobile application or the web portal makes calls to the APIs 260 in the background to implement functionality. The device data models 263 correspond to data models of mutable and/or immutable state maintained by the respective devices 112. The APIs 260 may facilitate read and/or write access to the device data models 263. The devices 112 may be configured to register with and communicate with a device management service 266, which may implement access via the APIs 260 and the device data model 263.

The client device 115 is representative of a plurality of client devices that may be coupled to the network 203. The client device 115 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, smartwatches, head mounted displays, voice interface devices, or other devices. The client device 115 may include a display comprising, for example, one or more devices such as liquid crystal display (LCD) displays, gas plasma-based flat panel displays, organic light emitting diode (OLED) displays, electrophoretic ink (E ink) displays, LCD projectors, or other types of display devices, etc. The client device 115 may be configured to execute various applications such as a client application used to interact with the device management service 209 and/or other applications.

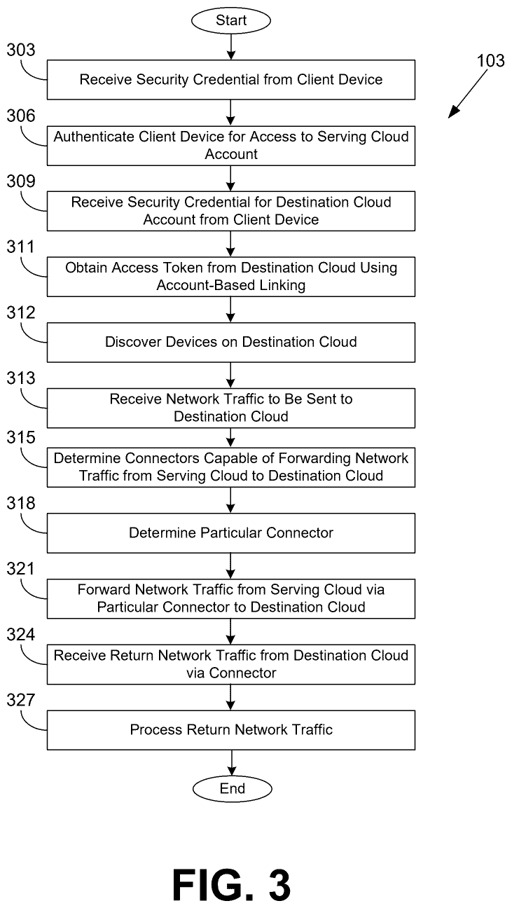

Referring next to FIG. 3, shown is a flowchart that provides one example of the operation of a portion of the serving cloud 103 according to various embodiments. It is understood that the flowchart of FIG. 3 provides merely an example of the many different types of functional arrangements that may be employed to implement the operation of the portion of the serving cloud 103 as described herein. As an alternative, the flowchart of FIG. 3 may be viewed as depicting an example of elements of a method implemented in the serving cloud 103 according to one or more embodiments.

Beginning with box 303, the device management service 209 in the serving cloud 103 receives a security credential from a client device 115 via the network 203. For example, a user 118 at the client device 115 may request to authenticate to the device management service 209, and the user 118 may be prompted to provide the security credential. Alternatively, the device management service 209 may authenticate the client device 115 based on an automatically presented credential such as in a cookie, a saved credential in a browser, or through key-based authentication.

In some cases, a third party separate from the serving cloud 103 receives the security credential from the client device 115 and performs the authentication. For example, a federated identity provider or another third-party service may receive the security credential and verify that it is valid. In such cases, the third-party service may pass a group identifier or owner identifier to the serving cloud 103 to confirm identity.

In box 306, the device management service 209 authenticates the client device 115 for access to an account with the serving cloud 103. For example, the device management service 209 may compare or otherwise evaluate the provided credential with respect to a stored security credential 241 in the data store 206.

In box 309, the device management service 209 receives a security credential from the client device 115 for an account with a destination cloud 106. For example, the user may request to add resources/devices 112 from the destination cloud 106 so that the device management service 209 is able to manage the resources/devices 112. Because the destination cloud 106 differs from the serving cloud 103, the customer may have a different account with the destination cloud 106 as compared to the account with the serving cloud 103. In other embodiments, the serving cloud 103 and the destination cloud 106 may use a single sign-on or federated identity service, which associates resources on both the serving cloud 103 and the destination cloud 106 with a single account. In box 311, the device management service 209 obtains an access token from or on behalf of the destination cloud 106 using account-based linking using the provided credential(s) and the account linking service 212. Where federated identity systems apply, the access token may be obtained using the same credential used to authenticate with the serving cloud 103.

In box 312, the device discovery service 218 performs device discovery to discover one or more devices 112 linked to the destination cloud 106 that are associated with the customer's account. In some cases, a connector 109 may be identified and selected to perform this discovery procedure. Subsequently, the customer may request to add a device 112 for management by the device management service 209 or otherwise generates network traffic to be sent to the device 112.

In box 313, the serving cloud 103 receives network traffic to be sent to the destination cloud 106. The network traffic may be generated by another device 112 in the serving cloud 103 or in another destination cloud 106 linked to the account of the serving cloud 103. Alternatively, the network traffic may be generated through user interaction with a mobile application, a web portal, or an API. For example, the network traffic may be a command for a device 112, a query for data from or respecting the device 112, and so on.

In box 315, the connector routing service 215 determines a plurality of connectors 109 that are capable of forwarding network traffic from the serving cloud 103 to the destination cloud 106. For example, the connector routing service 215 may examine the connector database 221 to assess which connectors 109 meet the requirements to route the traffic to the destination cloud 106. In various scenarios, multiple connectors 109 may meet the requirements. In some scenarios, one connector 109 may meet the requirement.

In box 318, the connector routing service 215 determines a particular connector 109 from the plurality of connectors 109 that are determined to be capable of forwarding the network traffic from the serving cloud 103 to the destination cloud 106. The particular connector 109 may be determined based at least in part on an evaluation of the connector selection rules 224. Parameters for the connector selection rules 224 may include QoS metrics 236 such as latency, jitter, reliability, bandwidth, etc., a set of required capabilities 239, whether the connector 109 is in a connector group 231 defined by the customer, and so on. In one example, the connector routing service 215 may identify a particular capability 239 invoked by the network traffic, and then determine that the corresponding set of capabilities 239 of the particular connector 109 supports the particular capability 239. Some connectors 109 may be associated with a higher priority tier than other connectors 109.

In box 321, the serving cloud 103 forwards the network traffic from the serving cloud 103 via a particular connector 109 to the destination cloud 106. The connector 109 is then able to translate and/or process the network traffic and to route it to the destination cloud 106. The serving cloud 103 may provide an appropriate access token to the connector 109 to enable the connector 109 to access the resources associated with forwarding the network traffic.

In box 324, the serving cloud 103 receives return network traffic from the destination cloud 106 by way of the particular connector 109. In box 327, the serving cloud 103 processes the return network traffic. For example, the return network traffic may be used to update a user interface served by the device management service 209. In another example, the return network traffic may be sent to another device 112 in the serving cloud 103 or in another destination cloud 106. Thereafter, the operation of the portion of the serving cloud 103 ends.

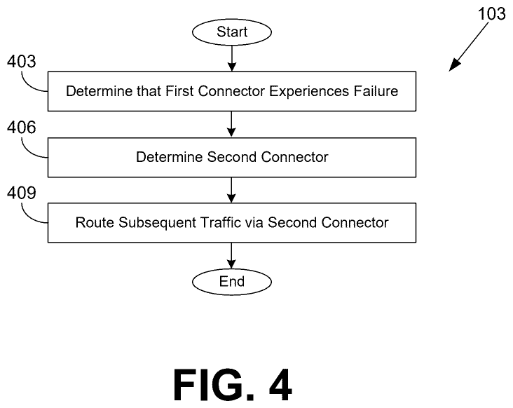

Turning now to FIG. 4, shown is a flowchart that provides one example of the operation of another portion of the serving cloud 103 according to various embodiments. It is understood that the flowchart of FIG. 4 provides merely an example of the many different types of functional arrangements that may be employed to implement the operation of the portion of the serving cloud 103 as described herein. As an alternative, the flowchart of FIG. 4 may be viewed as depicting an example of elements of a method implemented in the serving cloud 103 according to one or more embodiments.

Beginning with box 403, the connector routing service 215 determines that a first connector 109 between a serving cloud 103 and a destination cloud 106 is experiencing a failure. For example, the first connector 109 may have crashed or may be completely inaccessible. In another example, the first connector 109 may be operating poorly with lower QoS metrics 236, such as increased latency or reduced bandwidth.

In box 406, the connector routing service 215 determines a second connector 109 that is an alternative connector 109 capable of routing traffic from the serving cloud 103 to the destination cloud 106. For example, the second connector 109 may be in the same connector group 231 as the first connector 109. Otherwise, the connector routing service 215 may apply the connector selection rules 224 and evaluate the access requirements 233, QoS metrics 236, and capabilities 239 to ensure that the second connector 109 will meet the customer's objectives in terms of cost, QOS, or functionality/capabilities exposed by the second connector 109.

In box 409, the connector routing service 215 routes subsequent network traffic from the serving cloud 103 to the destination cloud 106 using the second connector 109 in place of the first connector 109. Thereafter, the operation of the portion of the serving cloud 103 ends.

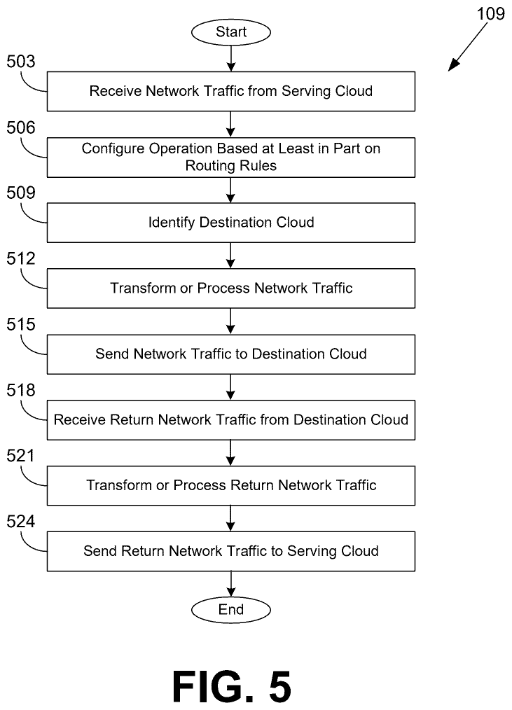

Moving on to FIG. 5, shown is a flowchart that provides one example of the operation of a portion of a connector 109 according to various embodiments. It is understood that the flowchart of FIG. 5 provides merely an example of the many different types of functional arrangements that may be employed to implement the operation of the portion of the connector 109 as described herein. As an alternative, the flowchart of FIG. 5 may be viewed as depicting an example of elements of a method implemented in the connector 109 according to one or more embodiments.

Beginning with box 503, the connector 109 receives network traffic from a serving cloud 103. For example, the network traffic may include commands for a device 112, queries for data relative to the device 112, and other network traffic. In box 506, the connector 109 may configure its operation based at least in part on the routing rules 227 pertaining to the network traffic. The routing rules 227 in some embodiments may be sent from the serving cloud 103 to the particular connector 109. In some embodiments, the connector 109 may have dynamic behaviors, such as providing high QoS or providing low QoS based upon customer identity, cost, subscription status, capabilities needed, and so on.

In box 509, the connector 109 identifies a destination cloud 106 associated with he network traffic. In box 512, the connector 109 may transform the network traffic to a format that is suitable for the destination cloud 106. For example, the connector 109 may translate an API call of the serving cloud 103 to an API call of the destination cloud 106. Also, the connector 109 may process the network traffic in some respect. For example, the connector 109 may transcode the data embodied in the network traffic, compress the data, summarize the data, and/or perform other processing actions. In some scenarios, the connector 109 may include or add identifiers of devices 112 in the network traffic that would be recognizable by the destination cloud 106. In box 515, the connector 109 sends the network traffic to the destination cloud 106.

In box 518, the connector 109 may receive return network traffic from the destination cloud 106. In box 521, the connector 109 may transform or process the return network traffic. For example, the connector 109 may translate an API call of the destination cloud 106 to an API call of the serving cloud 103. Also, the connector 109 may process the network traffic in some respect. For example, the connector 109 may transcode the data embodied in the network traffic, compress the data, summarize the data, and/or perform other processing actions. In box 524, the connector 109 sends the return network traffic to the serving cloud 103. Thereafter, the operation of the portion of the connector 109 ends.

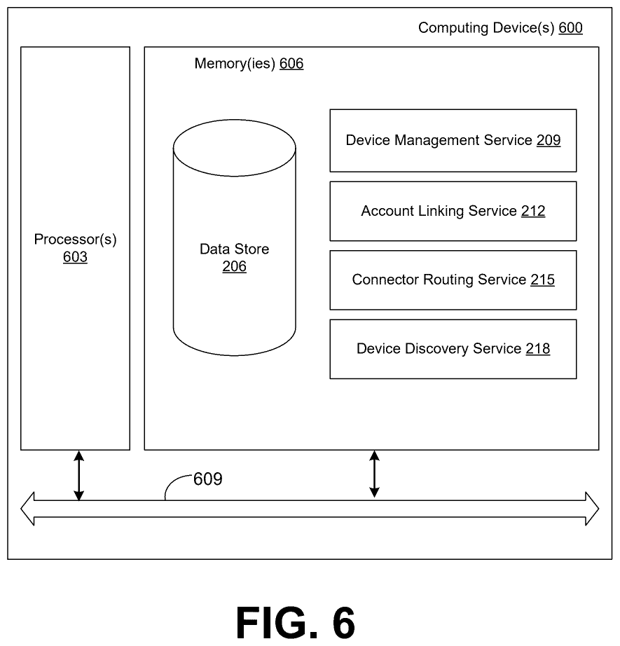

With reference to FIG. 6, shown is a schematic block diagram of the serving cloud 103 according to an embodiment of the present disclosure. The serving cloud 103 includes one or more computing devices 600. Each computing device 600 includes at least one processor circuit, for example, having a processor 603 and a memory 606, both of which are coupled to a local interface 609. To this end, each computing device 600 may comprise, for example, at least one server computer or like device. The local interface 609 may comprise, for example, a data bus with an accompanying address/control bus or other bus structure as can be appreciated.

Stored in the memory 606 are both data and several components that are executable by the processor 603. In particular, stored in the memory 606 and executable by the processor 603 are the device management service 209, the account linking service 212, the connector routing service 215, the device discovery service 218, and potentially other applications. Also stored in the memory 606 may be a data store 206 and other data. In addition, an operating system may be stored in the memory 606 and executable by the processor 603.

It is understood that there may be other applications that are stored in the memory 606 and are executable by the processor 603 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 606 and are executable by the processor 603. In this respect, the term “executable” means a program file that is in a form that can ultimately be run by the processor 603. Examples of executable programs may be, for example, a compiled program that can be translated into machine code in a format that can be loaded into a random access portion of the memory 606 and run by the processor 603, source code that may be expressed in proper format such as object code that is capable of being loaded into a random access portion of the memory 606 and executed by the processor 603, or source code that may be interpreted by another executable program to generate instructions in a random access portion of the memory 606 to be executed by the processor 603, etc. An executable program may be stored in any portion or component of the memory 606 including, for example, random access memory (RAM), read-only memory (ROM), hard drive, solid-state drive, universal serial bus (USB) flash drive, memory card, optical disc such as compact disc (CD) or digital versatile disc (DVD), floppy disk, magnetic tape, or other memory components.

The memory 606 is defined herein as including both volatile and nonvolatile memory and data storage components. Volatile components are those that do not retain data values upon loss of power. Nonvolatile components are those that retain data upon a loss of power. Thus, the memory 606 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 603 may represent multiple processors 603 and/or multiple processor cores and the memory 606 may represent multiple memories 606 that operate in parallel processing circuits, respectively. In such a case, the local interface 609 may be an appropriate network that facilitates communication between any two of the multiple processors 603, between any processor 603 and any of the memories 606, or between any two of the memories 606, etc. The local interface 609 may comprise additional systems designed to coordinate this communication, including, for example, performing load balancing. The processor 603 may be of electrical or of some other available construction.

Although the device management service 209, the account linking service 212, the connector routing service 215, the device discovery service 218, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 3-5 show the functionality and operation of an implementation of portions of the serving cloud 103 and the connectors 109. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 603 in a computer system or other system. The machine code may be converted from the source code, etc. If embodied in hardware, each block may represent a circuit or a number of interconnected circuits to implement the specified logical function(s).

Although the flowcharts of FIGS. 3-5 show a specific order of execution, it is understood that the order of execution may differ from that which is depicted. For example, the order of execution of two or more blocks may be scrambled relative to the order shown. Also, two or more blocks shown in succession in FIGS. 3-5 may be executed concurrently or with partial concurrence. Further, in some embodiments, one or more of the blocks shown in FIGS. 3-5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the device management service 209, the account linking service 212, the connector routing service 215, and the device discovery service 218, that comprises software or code can be embodied in any non-transitory computer-readable medium for use by or in connection with an instruction execution system such as, for example, a processor 603 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the device management service 209, the account linking service 212, the connector routing service 215, and the device discovery service 218, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 600, or in multiple computing devices 600 in the same serving cloud 103.

Unless otherwise explicitly stated, articles such as “a” or “an”, and the term “set”, should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A computer-implemented method, comprising:
obtaining, by a serving cloud, an access token for a destination cloud based at least in part on account-based linking;
performing, by the serving cloud, device discovery for devices linked to the destination cloud;
receiving, by the serving cloud, network traffic to be sent to the destination cloud, the network traffic being relative to a device managed in the destination cloud;
determining, based at least in part on a connector selection rule set, a particular cloud-to-cloud connector from a plurality of cloud-to-cloud connectors that are capable of forwarding the network traffic from the serving cloud to the destination cloud; and
forwarding the network traffic via the particular cloud-to-cloud connector to the destination cloud using the access token.

2. The computer-implemented method of claim 1, further comprising:
determining that the particular cloud-to-cloud connector has experienced a failure;
determining, based at least in part on the connector selection rule set, an alternative cloud-to-cloud connector from the plurality of cloud-to-cloud connectors; and
forwarding subsequent traffic of the network traffic via the alternative cloud-to-cloud connector to the destination cloud instead of via the particular cloud-to-cloud connector.

3. The computer-implemented method of claim 1, wherein the serving cloud is operated by a first entity, the destination cloud is operated by second entity, and the particular connector is operated by a third entity.

4. A system, comprising:
at least one computing device in a serving cloud; and
instructions executable in the at least one computing device, wherein when executed the instructions cause the at least one computing device to at least:
receive network traffic to be sent to a destination cloud different from the serving cloud, the network traffic being relative to a device managed in the destination cloud;
determine, based at least in part on a connector selection rule set, a particular connector from a plurality of connectors that are capable of forwarding the network traffic from the serving cloud to the destination cloud; and
forward the network traffic via the particular connector to the destination cloud.

5. The system of claim 4, wherein the serving cloud includes a control device located in an environment, and the device managed in the destination cloud is located in the environment.

6. The system of claim 4, wherein the instructions further cause the at least one computing device to at least receive return network traffic from the device via the particular connector.

7. The system of claim 6, wherein the instructions further cause the at least one computing device to at least:
determine, based at least in part on the connector selection rule set, a particular second connector from a plurality of second connectors that are capable of forwarding the return network traffic from the serving cloud to a second destination cloud; and
forward the return network traffic via the particular second connector to the second destination cloud.

8. The system of claim 4, wherein the instructions further cause the at least one computing device to at least:
perform account-based linking with the destination cloud based at least in part on a user-specified security credential;
obtain an access token from the account-based linking; and
provide the access token to the particular connector to enable the particular connector to perform device discovery for devices linked to the destination cloud and to communicate with the destination cloud regarding the device.

9. The system of claim 4, wherein a first connector of the plurality of connectors is associated with a higher priority tier than a second connector of the plurality of connectors.

10. The system of claim 4, wherein a first connector of the plurality of connectors is a publicly accessible connector, and a second connector of the plurality of connectors is a private connector that is not publicly accessible.

11. The system of claim 4, wherein each respective connector of the plurality of connectors is associated with a corresponding capability set, and determining the particular connector is further based at least in part on identifying a particular capability invoked by the network traffic and determining that the corresponding capability set of the particular connector supports the particular capability.

12. The system of claim 4, wherein the instructions further cause the at least one computing device to at least:
determine that the particular connector has experienced a failure;
determine, based at least in part on the connector selection rule set, an alternative connector from the plurality of connectors; and
forward subsequent traffic of the network traffic via the alternative connector to the destination cloud instead of via the particular connector.

13. The system of claim 12, wherein the particular connector and the alternative connector are in a user-defined connector group.

14. The system of claim 4, wherein the particular connector is configured to provide a dynamic behavior based at least in part on routing rules pertaining to the network traffic.

15. The system of claim 4, wherein the particular connector is selected based at least in part on a respective energy consumption of the particular connector compared to the plurality of connectors.

16. A computer-implemented method, comprising:
receiving, by a serving cloud, network traffic to be sent to a destination cloud different from the serving cloud, the network traffic being relative to a device managed in the destination cloud;
determining, based at least in part on a connector selection rule set, a particular connector that is capable of forwarding the network traffic from the serving cloud to the destination cloud; and
forwarding the network traffic via the particular connector to the destination cloud, wherein the particular connector provides a dynamic behavior based at least in part on routing rules.

17. The computer-implemented method of claim 16, further comprising sending the routing rules from the serving cloud to the particular connector, wherein the dynamic behavior provides different capabilities for the device according to the routing rules.

18. The computer-implemented method of claim 16, further comprising determining the particular connector based at least in part on the particular connector being in a user-defined connector group of a plurality of connectors, wherein the plurality of connectors in the user-defined connector group are capable of forwarding the network traffic from the serving cloud to the destination cloud.

19. The computer-implemented method of claim 16, further comprising:
determining that the particular connector has experienced a failure;
determining, based at least in part on the connector selection rule set, an alternative connector from a user-device connector group; and
forwarding subsequent traffic of the network traffic via the alternative connector to the destination cloud instead of via the particular connector.

20. The computer-implemented method of claim 16, further comprising:
performing account-based linking with the destination cloud based at least in part on a user-specified security credential;
obtaining an access token from the account-based linking; and
providing the access token to the particular connector to enable the particular connector to communicate with the destination cloud regarding the device.
